(19) United States
(12) Patent Application Publication
(10) Pub. No.: US 2025/0075340 A1
(43) Pub. Date: Mar. 6, 2025

(54) SOLID OXIDE COMPOSITE AND MANUFACTURING METHOD THEREOF

(71) Applicant: SAMSUNG ELECTRO-MECHANICS CO., LTD., Suwon-si, Gyeonggi-do (KR)

(72) Inventors: Jungdeok Park, Suwon-si, Gyeonggi-do (KR); Jaeseok Yi, Suwon-si, Gyeonggi-do (KR); Hongryul Lee, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/287,147

(22) PCT Filed: Sep. 22, 2023
(86) PCT No.: PCT/KR2023/014484

§ 371 Date: Oct. 16, 2023

(30) Foreign Application Priority Data
Dec. 6, 2022 (KR) 10-2022-0168885
Apr. 4, 2023 (KR) 10-2023-0044183

(51) Int. Cl. C25B 1/042; C25B 11/054; C25B 11/067; C25B 11/077; H01M 8/1213

(52) U.S. Cl. CPC C25B 1/042; C25B 11/054; C25B 11/067; C25B 11/077; H01M 8/1213

(57) ABSTRACT

A solid oxide composite according to present disclosure includes a solid oxide electrolyte including mesopores; and an oxide-based electrode active material in the mesopores.

### TECHNICAL FIELD

The present disclosure relates to a solid oxide composite and a manufacturing method thereof.

### BACKGROUND ART

A solid oxide fuel cell (SOFC) and a solid oxide electrolyzer cell (SOE) generate electrical energy through an electrochemical reaction of a cell composed of an air electrode, a fuel electrode, and a solid electrolyte having oxygen ionic conductivity or electrolyze water, and generate hydrogen through a reverse reaction of the solid oxide fuel cell. The cell has a configuration in which the air electrode and the fuel electrode are respectively disposed at both sides of the solid electrolyte having oxygen ionic conductivity. Air and hydrogen are respectively supplied to the air electrode and the fuel electrode through gas flow paths formed on a separator to have the electrochemical reaction to generate electricity or perform electrolysis.

In order to improve overall performance of the solid oxide fuel cell such as output characteristics and the like, research on electrode materials included in the air electrode and the fuel electrode is being actively conducted. Accordingly, the electrode materials tend to be mixed with an electrolyte rather than used alone, but a typical conventional process of physically simply mixing the individually synthesized electrode materials with the electrolyte has been used. However, there is a problem that the number of three-phase boundaries (TPB), which are effective reaction sites where electrode particles meet electrolyte particles, is insufficient.

### DISCLOSURE OF INVENTION

### Technical Problem

One aspect of the embodiment provides a solid oxide composite having a very large effective reaction area by contacting electrode particles and electrolyte particles in nano units.

Another aspect of the embodiment provides a method for manufacturing the solid oxide composite.

Another aspect of the embodiment provides a solid oxide fuel cell that includes the solid oxide composite to promote an electrochemical reaction of the cell to improve output characteristics of the cell and has excellent degradation stability even under high-temperature operating conditions.

Another aspect of the embodiment provides a solid oxide electrolysis cell including the solid oxide composite to improve output characteristics of the cell by accelerating an electrochemical reaction of the cell and to have excellent degradation stability even under high-temperature operating conditions.

However, problems to be solved by the embodiments are not limited to the above-described problems and may be variously extended in the range of technical ideas included in the embodiments.

### Solution to Problem

A solid oxide composite according to an embodiment includes a solid oxide electrolyte including mesopores; and an oxide-based electrode active material in the mesopores.

The mesopores of the solid oxide electrolyte may have an inverted gyroid structure.

An average size of the mesopores may be 2 to 50 nm.

A BET specific surface area of the solid oxide composite may be 5 to 200 m/g.

The oxide-based electrode active material may be included in an amount of 20 to 95 volume % based on the total volume of the mesopores.

A weight ratio of the solid oxide electrolyte and the oxide-based electrode active material may be 40:60 to 60:40.

The solid oxide electrolyte may include YSZ (yttria stabilized zirconia), ScSZ (scandia stabilized zirconia), GDC (gadolinia doped ceria), SDC (samaria doped ceria), LSGM (lanthanum-strontium-gallium-magnesium oxide), or a combination thereof.

The oxide-based electrode active material may include a fuel electrode active material, and the fuel electrode active material may include nickel oxide (NiO).

The oxide-based electrode active material may include an air electrode active material, and the air electrode active material may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

A method of manufacturing a solid oxide composite according to another embodiment includes filling first mesopores of a silica template with a solid oxide electrolyte; removing the silica template with a basic solution to prepare a solid oxide electrolyte including second mesopores; and filling the second mesopores of the solid oxide electrolyte with an oxide-based electrode active material.

The filling of the first mesopores of the silica template with the solid oxide electrolyte may include a first process of filling the first mesopores of the silica template with a portion of the solid oxide electrolyte precursor and a second process of filling the first mesopores of the silica template with the remaining solid oxide electrolyte precursor. A weight ratio of the solid oxide electrolyte precursor filled in the first mesopores in the first process and the solid oxide electrolyte precursor added to the first mesopores in the second process may be 1.5:1 to 3:1.

The filling of the oxide-based electrode active material in the second mesopores of the solid oxide electrolyte may be repeated 1 to 5 times.

The silica template may be MCM-41, MCM-48, MCM-50, SBA-11, SBA-12, SBA-15, SBA-16, KIT-5, KIT-6, FDU-2, or COK-12.

The first mesopores of the silica template may have a gyroid structure.

The first mesopores of the solid oxide electrolyte may have an inverted mesopore structure of the silica template.

The first mesopores of the solid oxide electrolyte may have an inverted gyroid structure.

A solid oxide fuel cell according to another embodiment includes an air electrode; a solid oxide electrolyte layer; and a fuel electrode, wherein the fuel electrode or the air electrode includes the solid oxide composite.

A solid oxide electrolysis cell according to another embodiment includes an air electrode; a solid oxide electrolyte layer; and a fuel electrode. The fuel electrode or the air electrode may include the solid oxide composite.

A solid oxide composite according to an embodiment includes an oxide-based electrode active material including mesopores and a solid oxide electrolyte in the mesopores.

A solid oxide composite according to an embodiment includes a solid oxide electrolyte and an oxide-based electrode active material. One of the solid oxide electrolyte and the oxide-based electrode active material includes a plurality of pores and another one of the solid oxide electrolyte and the oxide-based electrode active material is disposed in the plurality of pores, such that the solid oxide electrolyte and the oxide-based electrode active material are distributed among each other.

According to the solid oxide composite according to the embodiment, the electrode particles and the electrolyte particles are in nano-unit contact to have a very large effective reaction area, so that the electrochemical reaction of the cell is promoted to improve output characteristics of the cell, and it has an advantage of very high degradation stability even under high-temperature operating conditions.

### BRIEF DESCRIPTION OF THE DRAWINGS

FIG. 1 is a schematic view schematically showing a solid oxide composite according to an embodiment.

FIG. 2 is a schematic view schematically showing KIT-6, which is a type of silica template.

FIG. 3 is a schematic cross-sectional view of a solid oxide fuel cell according to an embodiment.

FIG. 4 is a transmission electron microscope (TEM) photograph of YSZ, which is a solid oxide electrolyte including mesopores.

FIG. 5 shows the results of BET analysis on the YSZ solid oxide electrolyte including mesopores and the solid oxide composites of Preparation Examples 1-1 to 1-4.

FIG. 6 shows the results of BET analysis on the solid oxide composite of Preparation Example 2-2.

FIG. 7 shows the results of BET specific surface area analysis of YSZ solid oxide electrolytes including mesopores and the solid oxide composites of Preparation Examples 1-1 to 1-4.

FIG. 8 shows the result of analyzing the BET specific surface area for the solid oxide composite of Preparation Example 2-2.

FIG. 9 shows the results of measuring the power density of solid oxide fuel cells including NiO-YSZ prepared in Preparation Example 1-3 and Comparative Preparation Example 1-5 in a fuel electrode, respectively.

FIG. 10 shows the result of measuring the power density of the solid oxide fuel cells including the LSM-YSZ prepared in Preparation Example 2-2 and Comparative Preparation Example 2-3 in the air electrode, respectively.

### MODE FOR THE INVENTION

Hereinafter, with reference to the accompanying drawings, the present invention will be described in detail so as to facilitate practice by one having ordinary skill in the art to which it belongs. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present invention includes all modifications, equivalents, and substitutions without departing from the scope and spirit of the present invention. In addition, some components are exaggerated, omitted, or schematically depicted in the accompanying drawings, and the dimensions of each component are not necessarily indicative of actual dimensions.

In addition, unless explicitly described to the contrary, the word “comprise”, and variations such as “comprises” or “comprising”, will be understood to imply the inclusion of stated elements but not the exclusion of any other elements.

Hereinafter, various embodiments and modifications will be described in detail with reference to the drawings.

### Solid Oxide Composite

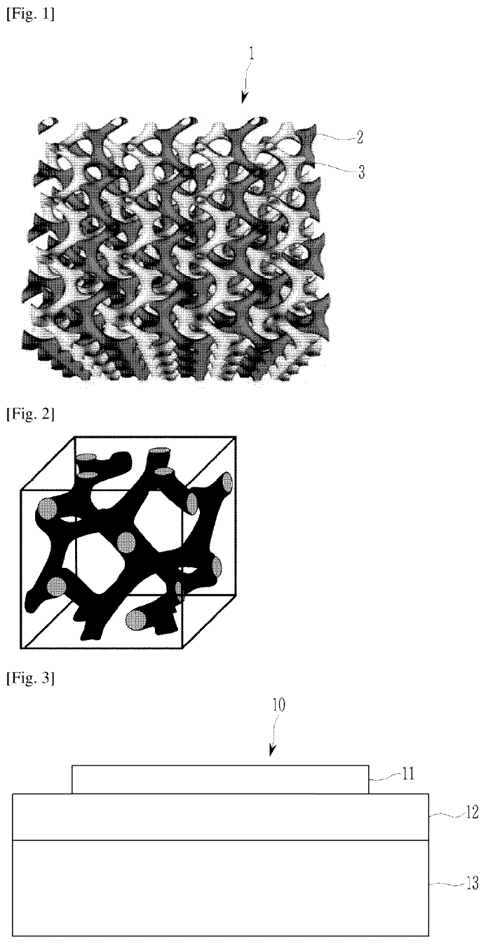

Referring to FIG. 1, a solid oxide composite 1 according to an embodiment includes a solid oxide electrolyte 2 including mesopores, and an oxide-based electrode active material 3 in the mesopores.

Since the oxide-based electrode active material 3 can contact the solid oxide electrolyte 2 by a nano unit of about 10 nm or less, the solid oxide composite 1 may have a very large number of three-phase boundaries (TPB), which are effective reaction areas. Accordingly, there are advantages of not only promoting an electrochemical reaction of the cell, improving output characteristics of the cell, but also maintaining many three-phase boundaries (TPB) under high-temperature operating conditions, much increasing degradation stability.

Unlike the solid oxide composite according to an embodiment, in a conventional solid oxide composite prepared by simply physically mixing a solid oxide electrolyte and an oxide-based electrode active material, since the solid oxide electrolyte and the oxide-based electrode active material independently grow, which increases a particle size and causes difficulty in securing the three-phase boundary (TPB) it is difficult to sufficiently secure electron and ion transfer paths.

In an embodiment, the mesopores of the solid oxide electrolyte may be an inverted mesopore structure of a silica template. For example, the mesopores of the solid oxide electrolyte may be an inverted gyroid structure.

The silica template may include MCM-41, MCM-48, MCM-50, SBA-11, SBA-12, SBA-15, SBA-16, KIT-5, KIT-6, FDU-2 or COK-12. For example, referring to FIG. 2, the silica template may be KIT-6.

For example, an average size of the mesopores may be 2 to 50 nm. For example, the average size or the mesopores may be 2 to 20 nm, or 2 to 10 nm.

The average size of the mesopores may be measured by sampling the solid oxide composite from electrodes of the solid oxide fuel cell or the solid oxide electrolysis cell itself, manufacturing it a sample with a thickness of about 100 nm or less and then, taking a transmission electron microscope (TEM) photograph thereof. The TEM photograph may be measured by adjusting the contrast in a method of binarizing the image and the like to define a relatively dark region as the solid oxide electrolyte and a relatively bright region as the oxide-based electrode active material. Herein, distances among the dark regions at 10 or more points may be measured and then, averaged to calculate the average size of the mesopores.

For example, the BET specific surface area of the solid oxide composite may be 5 to 200 m²/g. For example, the BET specific surface area of the solid oxide composite may be 5 to 100 m²/g, for example 5 to 50 m²/g or 10 to 40 m²/g. When the solid oxide composite satisfies the BET specific surface area within the above range, it is possible to realize a solid oxide composite with easy electron transfer while securing a large number of three-phase boundaries (TPB), which are effective reaction sites.

The BET (Brunauer Emmett Teller gas adsorption method) measurement is a method of measuring a specific surface area, a pore size, and distribution of pore sizes by adsorbing/desorbing gas (e.g., nitrogen) to the sample. The BET (gas adsorption method) measurement may be used to calculate the specific surface area on the surface of the sample by using a volume change of the adsorbed gas according to a pressure change. In addition, a correlation coefficient, which indicates a degree of agreement between a straight line and a C value (BET constant), which is a y-intercept of a BET plot, which is a graph of a volume of the adsorbed gas to a relative pressure, may be analyzed to evaluate reliability. Specifically, a shape of pores present in the sample may be predicted by a curve shape of the BET Plot graph. For example, when a hysteresis phenomenon, in which in the BET Plot graph, adsorption and desorption lines do not match, occurs, the sample may be predicted to have the mesopores.

For example, the oxide-based electrode active material may be included in an amount of 20 to 95 volume % based on the total volume of the mesopores. For example, the fuel electrode active material may be included in 40 to 80 volume %, or 50 to 80 volume % based on the total volume of the mesopores. If the range is satisfied, it is possible to realize a solid oxide composite with easy electron transfer while securing a large number of three-phase boundaries (TPB), which are effective reaction sites.

A weight ratio of the solid oxide electrolyte and the oxide-based electrode active material may be 40:60 to 60:40. If the weight ratio of the range is satisfied, it is possible to realize a solid oxide composite with easy electron transfer while securing a large number of three-phase boundaries (TPB), which are effective reaction sites.

In an embodiment, the solid oxide electrolyte may be used without limitation as long as it is commonly used.

For example, the solid oxide electrolyte may include at least one selected from a zirconia-based solid electrolyte doped or undoped with at least one of yttrium, scandium, calcium, and magnesium; a ceria-based solid electrolyte doped or undoped with at least one of gadolinium, samarium, lanthanum, ytterbium, and neodymium; a bismuth oxide-based solid electrolyte doped or undoped with at least one of calcium, strontium, barium, gadolinium, and yttrium; and at least one of lanthanum gallate-based solid electrolyte doped or undoped with at least one of strontium and magnesium.

For example, YSZ (yttria stabilized zirconia), ScSZ (scandia stabilized zirconia), GDC (gadolinia doped ceria), SDC (samaria doped ceria), LSGM (lanthanum-strontium-gallium-magnesium oxide), or a combination thereof may be included.

The oxide-based electrode active material may include a fuel electrode active material, an air electrode active material, or both of them.

The fuel electrode active material may be any commonly used material without limitation. For example, the fuel electrode active material may include nickel (Ni), cobalt (Co), ruthenium (Ru), palladium (Pd), platinum (Pt), an oxide thereof, or a combination thereof, for example, nickel oxide (NiO).

The air electrode may not be particularly limited, as long as generally used in the related art, and for example, may include metal oxide particles having a perovskite-type crystal structure. The perovskite-type metal oxide is a mixed ionic and electronic conductor (MIEC) material having both ionic conductivity and electronic conductivity, and has a high oxygen diffusion coefficient and a charge exchange reaction rate coefficient, so that an oxygen reduction reaction may occur on the entire surface of the electrode, not just at the three-phase boundary, may improve electrode activity at low temperatures, and thus may contribute to lowering the operating temperature of the SOFC.

The perovskite-type metal oxide may be represented by Chemical Formula 1.

ABO_{3±δ} [Chemical Formula 1]

In Chemical Formula 1, A is at least one element selected from La, Ba, Sr, Sm, Gd, and Ca, B is at least one element selected from Mn, Fe, Co, Ni, Cu, Ti, Nb, Cr, and Sc, and δ indicates an oxygen excess or deficiency.

The δ may be for example, in the range of 0≤δ≤0.3.

For example, the perovskite-type metal oxide may be represented by Chemical Formula 2.

A′₁₋ₓA″ₓB′O_{3±γ} [Chemical Formula 2]

In Chemical Formula 2, A′ is at least one element selected from Ba, La, and Sm, A″ is at least one element selected from Sr, Ca, and Ba and is different from A′, and B′ is at least one element selected from Mn, Fe, Co, Ni, Cu, Ti, Nb, Cr, and Sc, 0≤x<1, and γ indicates an oxygen excess or deficiency.

The γ may be for example, in the range of 0≤γ≤0.3.

Examples of such perovskite-type metal oxides may include a barium strontium cobalt iron oxide (BSCF), a lanthanum strontium cobalt oxide (LSC), a lanthanum strontium cobalt iron oxide (LSCF), a lanthanum strontium cobalt manganese oxide (LSCM), a lanthanum strontium iron oxide (LSF), a samarium strontium cobalt oxide (SSC), and the like.

Specifically, it may include Ba₁₋ₓSrₓCo_{1-y}Fe_{y}O₃ (wherein 0.1≤x≤0.5, 0.05≤y≤0.5), BaₐSr_{b}CoₓFe_{y}Z_{1-x-y}O_{3±γ} (wherein Z is at least one element selected from transition metal elements and lanthanide elements, 0.4≤a≤0.6, 0.4≤b≤0.6, 0.6≤x≤0.9, 0.1≤y≤0.4), La₁₋ₓSrₓFe_{1-y}Co_{y}O_{3±γ} (wherein 0.1≤x≤0.4, 0.05≤y≤0.5), Sm₁₋ₓSrₓCoO₃ (where 0.1≤x≤0.5), and the like. For example, it may include an oxide such as Ba_{0.5}Sr_{0.5}Co_{0.8}Fe_{0.2}O_{3±γ}, Ba_{0.5}Sr_{0.5}Co_{0.8}Fe_{0.1}Z_{0.1}O_{3±γ} (wherein, Z is Mn, Zn, Ni, Ti, Nb, or Cu), La_{0.6}Sr_{0.4}Co_{0.2}Fe_{0.8}O_{3±γ}, Sm_{0.5}Sr_{0.5}CoO₃, and the like. These perovskite-type metal oxides may be used alone or in combination of two or more.

As a specific example, the air electrode active material may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

### Method of Manufacturing Solid Oxide Composite

A method of manufacturing a solid oxide composite according to an embodiment includes filling mesopores of a silica template with a solid oxide electrolyte; removing the silica template with a basic solution to prepare a solid oxide electrolyte including mesopores; and filling the mesopores of the solid oxide electrolyte with an oxide-based electrode active material.

In an embodiment, the filling of the mesopores of the silica template with the solid oxide electrolyte may include a first process of filling the mesopores of the silica template with a portion of the solid oxide electrolyte precursor and a second process of filling the mesopores of the silica template with the remaining solid oxide electrolyte precursor.

A weight ratio of the solid oxide electrolyte precursor filled in the mesopores in the first process and the solid oxide electrolyte precursor added to the mesopores in the second process may be 1.5:1 to 3:1.

As described above, when the mesopores are filled through two steps, the mesopores may be evenly filled, while minimizing an amount of the solid oxide electrolyte precursor accumulated around the silica template.

The removing the silica template with the basic solution to prepare a solid oxide electrolyte including mesopores adopts an alkali etching method, in which the silica template is removed (etched) by using a basic solution.

The basic solution may use any solution used in the related art without limitation. For example, the basic solution may include a sodium hydroxide aqueous solution (NaOH) or a potassium hydroxide aqueous solution (KOH).

The filling the mesopores of the solid oxide electrolyte with an oxide-based electrode active material may be once to five times repeated, for example, three times to four times repeated, for example, three times repeated.

When the filling the mesopores of the solid oxide electrolyte with an oxide-based electrode active material is excessively repeated, a ratio of the solid oxide electrolyte and the oxide-based electrode active material may be imbalanced, so that the oxide-based electrode active material or the solid oxide electrolyte may not properly be connected, resulting in a shortage of electron transfer paths.

When the filling of the oxide-based electrode active material in the mesopores of the solid oxide electrolyte is repeated within the number of times, a solid oxide composite with easy electron transfer may be prepared while securing a large number of three-phase boundaries (TPB), which are effective reaction sites.

The silica template may include MCM-41, MCM-48, MCM-50, SBA-11, SBA-12, SBA-15, SBA-16, KIT-5, KIT-6, FDU-2 or COK-12. For example, referring to FIG. 2, the silica template may be KIT-6.

The mesopores of the silica template may be interpenetrating bicontinuous pores. For example, the mesopores of the silica template may be a gyroid structure.

The gyroid structure is a three-dimensional structure having two independent pores three-dimensionally connected and maintaining infinite surfaces at regular intervals. The gyroid structure has regularly arranged pores with a size of about 10 nm and features a large surface area.

For example, the mesopores of the solid oxide electrolyte may be an inverted mesopore structure of the silica template. For example, the mesopores of the solid oxide electrolyte may be an inverted gyroid structure. The reason is that when the silica template is removed after filling the mesopores of the silica template with the solid oxide electrolyte, the mesopores of the solid oxide electrolyte have an inverted shape of the silica template mesopores.

### Solid Oxide Fuel Cell and Solid Oxide Electrolysis Cell

FIG. 3 is a cross-sectional view schematically showing the structure of a solid oxide fuel cell (SOFC) according to an embodiment. Referring to FIG. 3, the solid oxide fuel cell 10 includes an air electrode 11; a solid oxide electrolyte layer 12; and a fuel electrode 13. The fuel electrode 13 or the air electrode 11 includes the aforementioned solid oxide composite.

A solid oxide electrolysis cell (SOEC) according to another embodiment includes an air electrode: a solid oxide electrolyte layer; and a fuel electrode. The fuel electrode or the air electrode includes the aforementioned solid oxide composite.

The solid oxide composite may include a solid oxide electrolyte including mesopores; and an oxide-based electrode active material in the mesopores.

Since the materials of the solid oxide composite, the solid oxide electrolyte including mesopores, and the electrode (air electrode, fuel electrode) are the same as those described in detail above, descriptions thereof are omitted.

By including the aforementioned solid oxide composite in the air electrode, the fuel electrode, or both of the electrodes included in the solid oxide fuel cell and the solid oxide electrolysis cell, an electrochemical reaction of the cell is promoted to improve output characteristics of the cell and to implement batteries and cells with very high degradation stability even under high-temperature operating conditions.

In the SOFC and the SOEC, only ions and electrons move in opposite directions, and an air electrode, a solid oxide electrolyte layer, a fuel electrode constituting a cell are the same. Hereinafter, a solid oxide fuel cell (SOFC) will be described in detail. Excluding the descriptions described above, the configuration of the cell will be described in detail.

The air electrode 11 reduces oxygen gas (O₂) to generate oxygen ions (O²⁻), and continuously supplies air to the air electrode 11 to maintain a constant partial pressure of oxygen. The generated oxygen ions move toward the solid oxide electrolyte layer 12.

The air electrode 11 may have a thickness of 1 μm to 100 μm. For example, a thickness of the first air electrode 11 may be 5 μm to 50 μm.

The air electrode 11 desirably has porosity so that oxygen gas can be well diffused therein.

The solid oxide electrolyte layer 12 serves to transport oxygen ions generated in the air electrode 11 to the fuel electrode 13 through ion conduction. The solid oxide electrolyte layer 12 has gas impermeability to block contact between the air electrode and fuel electrode, and has high oxygen ionic conductivity and low electronic conductivity (high electrical resistance, high insulation), so that electrons generated from the fuel electrode may be blocked from directly moving to the air electrode.

In addition, since the air electrode 11 and the fuel electrode 13 having a very large oxygen partial pressure difference are on both sides of the solid oxide electrolyte layer 12, the aforementioned properties may be necessary to maintain in a wide oxygen partial pressure region.

The material constituting the solid oxide electrolyte layer 12 is not particularly limited as long as it is generally usable in the art, and may include at least one be selected from, for example, zirconia-based, ceria-based, bismuth oxide-based, and lanthanum gallate-based solid electrolytes.

For example, the solid oxide electrolyte layer 12 may be a zirconia-based solid electrolyte doped or undoped with at least one of yttrium, scandium, calcium, and magnesium; a ceria-based solid electrolyte doped or undoped with at least one of gadolinium, samarium, lanthanum, ytterbium, and neodymium; a bismuth oxide-based solid electrolyte doped or undoped with at least one of calcium, strontium, barium, gadolinium, and yttrium; and at least one of lanthanum gallate-based solid electrolyte doped or undoped with at least one of strontium and magnesium Specific examples of materials included in the solid oxide electrolyte layer 12 may include yttria stabilized zirconia (YSZ), scandia stabilized zirconia (ScSZ), sanaria doped ceria (SDC), gadolinia doped ceria (GDC), and the like.

A thickness of the solid oxide electrolyte layer 12 may be typically 10 nm to 100 μm. For example, the thickness of the solid oxide electrolyte layer 12 may be 100 nm to 50 μm.

The fuel electrode 13 serves to electrochemically oxidize fuel and transfer charges. The fuel electrode 13 may serve to generate H₂O by reacting hydrogen supplied from the outside with oxygen ions transferred from the solid oxide electrolyte layer 12. In this process, electrons are generated, and the generated electrons may be moved toward the air electrode 11 through a load.

In addition to the solid oxide composite, the fuel electrode 13 may include a fuel electrode active material generally usable in the art. For example, NiO-YSZ, NiO-ScSZ, NiO-GDC, NiO-SDC NiO-doped BaZrO₃, Ru, Pd. Rd, or Pt may be included.

The fuel electrode 13 may have a thickness of 1 μm to 1000 μm. For example, the fuel electrode 13 may have a thickness of 5 μm to 100 μm.

According to an embodiment, the solid oxide fuel cell 10 further includes an electrical collecting layer (not shown) including an electron conductor on at least one side surface of the air electrode 11, for example, an outer side surface of the air electrode 11.

The electrical collecting layer may act as a current collector to collect electricity in a configuration of the air electrode.

The electrical collecting layer may include, for example, at least one of a lanthanum cobalt oxide (LaCoO₃), a lanthanum strontium cobalt oxide (LSC), a lanthanum strontium cobalt iron oxide (LSCF), a lanthanum strontium cobalt manganese oxide (LSCM), a lanthanum strontium manganese oxide (LSM), and a lanthanum strontium iron oxide (LSF). The electrical collecting layer may use the above-listed materials alone or in a combination of two or more. These materials may be formed into a single layer or two or more layers with a stacked structure.

The solid oxide cell may be manufactured in conventional methods known in various literature in the art. The solid oxide cells may be applied to various structures such as a cylindrical (tubular) stack, a flat tubular stack, a planar-type stack, and the like.

Hereinafter, specific examples of the invention are presented. However, the examples described below are only intended to specifically illustrate or explain the invention, and the scope of the invention should not be limited thereto.

### Preparation Examples

### Preparation Example 1-1: Preparation of Solid Oxide Composite NiO-YSZ 1

3.2 g of a YSZ precursor prepared by mixing 3.029 g of ZrOCl₂·8H₂O and 0.171 g of Y(NO₃)₃·6H₂O is mixed with a mixed solvent of 15 ml of ethanol and 5 ml of water. Thus, primary precursor slurry is prepared.

After mixing the primary precursor slurry with 1.2 g of a silica template KIT-6, the solvent is evaporated at 70° C. in a petri dish. After evaporating all the solvent, the residue is fired to 350° C. and then, maintained at the highest temperature for 4 hours. Thus, a primary product is prepared.

1.6 g of a YSZ precursor prepared by mixing 1.5145 g of ZrOCl₂·8H₂O and 0.0855 g of Y(NO₃)₃·6H₂O is mixed in a mixed solvent of 7.5 ml of ethanol and 2.5 ml of water. Thus, secondary precursor slurry is prepared.

After mixing the secondary slurry with the primary product, the solvent is evaporated at 70° C. in a petri dish. After evaporating all the solvent, the residue is fired to 550° C. and then, maintained at the highest temperature for 4 hour. Thus, a secondary product is prepared.

The secondary product is fired at 2° C./min to 650° C. for 5 hours and 10 minutes and then, maintained at the highest temperature for 2 hours, which is performed as a final firing.

The prepared secondary product is put in 1.33 g of a 1 M NaOH aqueous solution (prepared by mixing 200 ml of water and 8 g of NaOH) and maintained there at 90° C. for 2 hours and then, put again in 2.45 g of the same 1 M NaOH aqueous solution and maintained there at 90° C. for 2 hours to remove KIT-6.

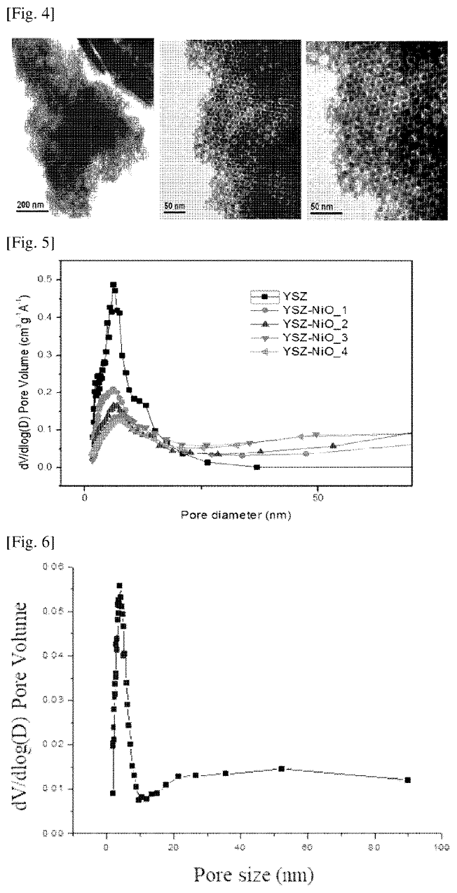

FIG. 4 shows that a YSZ solid oxide electrolyte including mesopores (average pore size: 10 nm) produced after removing KIT-6.

3.5 g of Ni(NO₃)₂·6H₂O, which is a NiO fuel electrode precursor, is mixed with a mixed solvent of 15 ml of ethanol and 5 ml of water to prepare fuel electrode slurry, and then, the fuel electrode slurry is once coated on the YSZ solid oxide electrolyte, manufacturing a solid oxide composite NiO-YSZ 1.

### Preparation Example 1-2: Preparation of Solid Oxide Composite NiO-YSZ 2

A solid oxide composite NiO-YSZ 2 is prepared in the same manner as in Preparation Example 1 except that the fuel electrode slurry coating process is twice repeated in Preparation Example 1-1.

### Preparation Example 1-3: Preparation of Solid Oxide Composite NiO-YSZ 3

A solid oxide composite NiO-YSZ 3 is prepared in the same manner as in Preparation Example 1 except that the fuel electrode slurry coating process is three times repeated in Preparation Example 1-1.

### Preparation Example 1-4: Preparation of Solid Oxide Composite NiO-YSZ 4

A solid oxide composite NiO-YSZ 4 is prepared in the same manner as in Preparation Example 1 except that the fuel electrode slurry coating process is four times repeated in Preparation Example 1-1.

### Comparative Preparation Example 1-5

A solid oxide composite NiO-YSZ is prepared in a simple physical mixing method.

### Preparation Example 2-1: Preparation of Solid Oxide Composite LSM-YSZ 1

A solid oxide composite LSM-YSZ 1 is prepared in the same manner as in Preparation Example 1-1 except that 3.5 g of a LSM air electrode precursor including La(NO₃)·6H₂O, Sr(NO₃)₃·4H₂O, and Mn(NO₃)₂·6H₂O is mixed with a mixed solvent of 15 ml of ethanol and 5 ml of water to prepare air electrode slurry, and the YSZ solid oxide electrolyte according to Preparation Example 1-1 is coated with the air electrode slurry.

### Preparation Example 2-2: Preparation of Solid Oxide Composite LSM-YSZ 3

A solid oxide composite LSM-YSZ 3 is prepared in the same method as in Preparation Example 2-1 except that the air electrode slurry coating process is three times repeated in Preparation Example 2-1.

### Comparative Preparation Example 2-3

A solid oxide composite LSM-YSZ is prepared in a simple physical mixing method.

### Experimental Examples

### Experimental Example 1: BET Analysis of Solid Oxide Composite

The solid oxide electrolyte YSZ including mesopores and the solid oxide composites NiO-YSZ 1 to 4 (Preparation Examples 1-1 to 1-4) are BET-analyzed, and the results are shown in FIG. 5.

In addition, the solid oxide composite LSM-YSZ 3 (Preparation Example 2-2) is BET-analyzed, and the result is shown in FIG. 6.

In FIG. 5 and FIG. 6, a horizontal axis represents a size of the mesopores, and a vertical axis represents a volume of the mesopores. FIG. 5 shows that the volume of the mesopores decreases according to the number of times of coating the fuel electrode active material, and FIGS. 5 and 6 show that the mesopores exhibit a size distribution of about 10 nm or less. Accordingly, the mesopores produced in the solid oxide composites have an average size of about 10 nm or less.

### Experimental Example 2: BET Specific Surface Area Analysis of Solid Oxide Composite

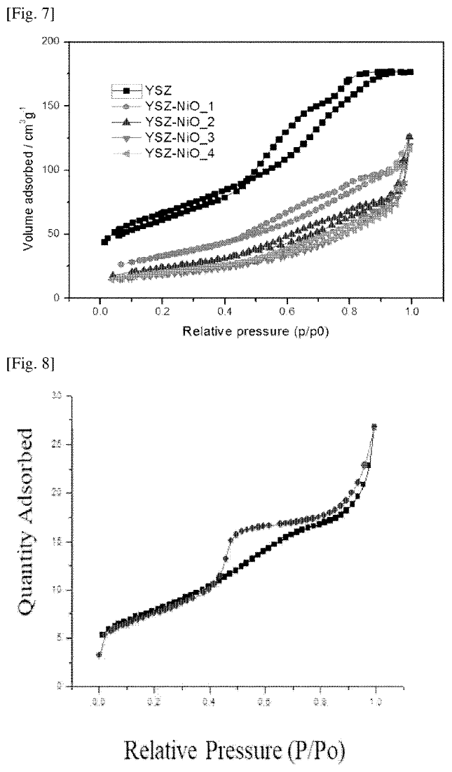

The solid oxide electrolyte YSZ and the solid oxide electrolytes NiO-YSZ 1 to 4 including mesopores (Preparation Examples 1-1 to 1-4) are analyzed with respect to a BET specific surface area, and the results are shown in FIG. 7.

In addition, the solid oxide composite LSM-YSZ 3 (Preparation Example 2-2) is analyzed with respect to a BET specific surface area, and the result is shown in FIG. 8.

Referring to FIGS. 7 and 8, since all graphs confirm that a hysteresis phenomenon, in which an adsorption and desorption curves do not match, occurs, the solid oxide composites NiO-YSZ 1 to 4 and the solid oxide composite LSM-YSZ 3 all include mesopores.

### Experimental Example 3: Electrical Characteristic Analysis of Solid Oxide Fuel Cell

Each solid oxide fuel cell is manufactured to include NiO-YSZ 3 of Preparation Example 1-3 and NiO-YSZ of Comparative Preparation Example 1-5 in each fuel electrode and then, measured with respect to power density, and the results are shown in FIG. 9.

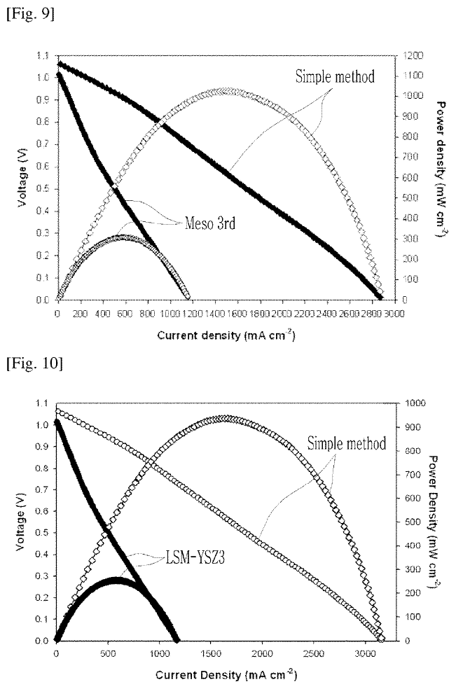

In addition, each solid oxide fuel cell is manufactured to include LSM-YSZ 3 of Preparation Example 2-2 and LSM-YSZ of Comparative Preparation Example 2-3 in each air electrode and then, measured with respect to power density, and the results are shown in FIG. 10.

The solid oxide fuel cell including the solid oxide composite NiO-YSZ 3 according to an embodiment in the fuel electrode or the solid oxide fuel cell including the solid oxide composite LSM-YSZ 3 in the fuel electrode, since electrode particles and electrolyte particles may contact each other by a nano unit of about 10 nm or less, have a three-phase boundary (TPB), which is a very large effective reaction area and thus promotes an electrochemical reaction, thereby improving output characteristics.

On the other hand, the solid oxide fuel cell including NiO-YSZ prepared through simple mixing in the fuel electrode or LSM-YSZ prepared through simple mixing in the air electrode, since the solid oxide electrolyte and the oxide-based electrode active material independently grow, may not secure the three-phase boundary (TPB) and thus fail in sufficiently securing electron transfer paths, exhibiting relatively much deteriorated output characteristics.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### INDUSTRIAL APPLICABILITY

The present disclosure relates to a solid oxide fuel cell (SOFC) or a solid oxide electrolysis cell (SOEC) that improves output characteristics of the cell by accelerating an electrochemical reaction of the cell and to have excellent degradation stability even under high-temperature operating conditions, and may be used in various electrochemical devices and electronic devices.

### DESCRIPTION OF SYMBOLS

1: solid oxide composite
2: solid oxide electrolyte
3: oxide-based electrode active material
10: solid oxide fuel cell
11: air electrode
12: solid oxide electrolyte layer
13: fuel electrode

1. A solid oxide composite, comprising:
a solid oxide electrolyte including mesopores; and
an oxide-based electrode active material in the mesopores.

2. The solid oxide composite of claim 1, wherein
the mesopores of the solid oxide electrolyte have an inverted gyroid structure.

3. The solid oxide composite of claim 1, wherein
an average size of the mesopores is 2 to 50 nm.

4. The solid oxide composite of claim 1, wherein
a BET specific surface area of the solid oxide composite is 5 to 200 m²/g.

5. The solid oxide composite of claim 1, wherein
the oxide-based electrode active material is included in an amount of 20 to 95 volume % based on the total volume of the mesopores.

6. The solid oxide composite of claim 1, wherein
a weight ratio of the solid oxide electrolyte and the oxide-based electrode active material is 40:60 to 60:40.

7. The solid oxide composite of claim 1, wherein
the solid oxide electrolyte includes YSZ (yttria stabilized zirconia), ScSZ (scandia stabilized zirconia), GDC (gadolinia doped ceria), SDC (samaria doped ceria), LSGM (lanthanum-strontium-gallium-magnesium oxide), or a combination thereof.

8. The solid oxide composite of claim 1, wherein
the oxide-based electrode active material includes a fuel electrode active material, and the fuel electrode active material includes nickel oxide (NiO).

9. The solid oxide composite of claim 1, wherein
the oxide-based electrode active material includes an air electrode active material, and
the air electrode active material includes a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

10. A method of manufacturing a solid oxide composite, comprising filling first mesopores of a silica template with a solid oxide electrolyte; removing the silica template with a basic solution to prepare a solid oxide electrolyte including second mesopores; and
filling the second mesopores of the solid oxide electrolyte with an oxide-based electrode active material.

11. The method of claim 10, wherein
the filling of the first mesopores of the silica template with the solid oxide electrolyte includes a first process of filling the first mesopores of the silica template with a portion of the solid oxide electrolyte precursor and a second process of filling the first mesopores of the silica template with the remaining solid oxide electrolyte precursor, wherein a weight ratio of the solid oxide electrolyte precursor filled in the first mesopores in the first process and the solid oxide electrolyte precursor added to the first mesopores in the second process is 1.5:1 to 3:1.

12. The method of claim 10, wherein
the filling of the oxide-based electrode active material in the second mesopores of the solid oxide electrolyte is repeated 1 to 5 times.

13. The method of claim 10, wherein
the silica template includes MCM-41, MCM-48, MCM-50, SBA-11, SBA-12, SBA-15, SBA-16, KIT-5, KIT-6, FDU-2, or COK-12.

14. The method of claim 10, wherein
the first mesopores of the silica template have a gyroid structure.

15. The method of claim 10, wherein
the second mesopores of the solid oxide electrolyte have an inverted mesopore structure of the silica template.

16. The method of claim 10, wherein
the mesopores of the solid oxide electrolyte have an inverted mesopore structure of the silica template.

17. A solid oxide fuel cell, comprising
an air electrode;
a solid oxide electrolyte layer; and
a fuel electrode,
wherein the fuel electrode or the air electrode includes the solid oxide composite of claim 1.

18. A solid oxide electrolysis cell, comprising
an air electrode;
a solid oxide electrolyte layer; and
a fuel electrode,
wherein the fuel electrode or the air electrode includes the solid oxide composite of claim 1.

19. A solid oxide composite, comprising:
an oxide-based electrode active material including mesopores; and
a solid oxide electrolyte in the mesopores.

20. The solid oxide composite of claim 19, wherein an average size of the mesopores is 2 to 50 nm.

21. The solid oxide composite of claim 19, wherein a weight ratio of the solid oxide electrolyte and the oxide-based electrode active material is 40:60 to 60:40.

22. The solid oxide composite of claim 19, wherein
the solid oxide electrolyte includes YSZ (yttria stabilized zirconia), ScSZ (scandia stabilized zirconia), GDC (gadolinia doped ceria), SDC (samaria doped ceria), LSGM (lanthanum-strontium-gallium-magnesium oxide), or a combination thereof.

23. The solid oxide composite of claim 19, wherein the oxide-based electrode active material includes a fuel electrode active material, and the fuel electrode active material includes nickel oxide (NO).

24. The solid oxide composite of claim 19, wherein the oxide-based electrode active material includes an air electrode active material, and
the air electrode active material includes a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

25. A solid oxide composite, comprising:
a solid oxide electrolyte and an oxide-based electrode active material, wherein one of the solid oxide electrolyte and the oxide-based electrode active material includes a plurality of pores and another one of the solid oxide electrolyte and the oxide-based electrode active material is disposed in the plurality of pores, such that the solid oxide electrolyte and the oxide-based electrode active material are distributed among each other.

26. The solid oxide composite of claim 25, wherein a weight ratio of the solid oxide electrolyte and the oxide-based electrode active material is 40:60 to 60:40.

27. The solid oxide composite of claim 25, wherein the solid oxide electrolyte includes YSZ (yttria stabilized zirconia), ScSZ (scandia stabilized zirconia), GDC (gadolinia doped ceria), SDC (samaria doped ceria), LSGM (lanthanum-strontium-gallium-magnesium oxide), or a combination thereof.

28. The solid oxide composite of claim 25, wherein the oxide-based electrode active material includes a fuel electrode active material, and the fuel electrode active material includes nickel oxide (NiO).

29. The solid oxide composite of claim 25, wherein the oxide-based electrode active material includes an air electrode active material, and
the air electrode active material includes a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.
